(19) United States
(12) Patent Application Publication
(10) Pub. No.: US 2023/0168688 A1
(43) Pub. Date: Jun. 1, 2023

(54) SEQUENTIAL MAPPING AND LOCALIZATION (SMAL) FOR NAVIGATION

(71) Applicant: SINGPILOT PTE LTD, Singapore (SG)

(72) Inventor: Zhiwei SONG, Singapore (SG)

(21) Appl. No.: 17/789,519

(22) PCT Filed: Feb. 3, 2020
(86) PCT No.: PCT/SG2020/050050

§ 371 Date: Jun. 28, 2022

(30) Foreign Application Priority Data
Dec. 30, 2019 (SG) 10201913873Q

(51) Int. Cl. G05D 1/02; G06T 7/13; G06T 7/579; G06T 7/73; G06T 5/00

(52) U.S. Cl. CPC G05D 1/0274; G05D 1/0212; G06T 5/002; G06T 7/13; G06T 7/73; G06T 7/579; G06T 2207/20182; G06T 2207/20221

(57) ABSTRACT

A method of sequential mapping and localization (SMAL) is disclosed for navigating a mobile object (i.e. SMAL method). The SMAL method comprises a step of generating an initial map of an unknown environment in a mapping process; a step of determining a location of the mobile object in the initial map in a localization process; and a step of guiding the mobile object in the unknown environment, e.g. by creating a control or an instruction to the mobile object. A system using the SMAL method and a computer program product for implementing the SMAL method are also disclosed accordingly.

[symbol] when a satellite signal of the GNSS is easily blocked by the gantry crane or stacked containers in the container terminal. The HD-map has multiple-purposes, such as structural objects for localization, lane connections with marking formation for path planning; and detailed marking locations for the good looking Graphical User Interface (GUI). So the HD-Map is generated independently and is still based on structural objects in the HD-map, such as buildings, trees, poles and etc.

Meanwhile, the SLAM solution also does not perform to a satisfactory degree when there are few fixed surrounding objects in an open environment, such as the container terminal as well as an airport field. For example, although there are many containers in the container terminal, they are not fixed and their position change a lot which will affect the localization result of SLAM solution in a bad way. In the container terminal, no autonomous vehicle has been deployed yet, but only the Automated Guided Vehicle (AGV) which requires massive beacons to be deployed in the environment, such as Radio-Frequency Identification (RFID) tags or Ultra-wideband (UWB) stations.

[0005a] The background in relation to the subject application includes an article “The HUGIN real-time terrain navigation system” published in pages 1-7 of OCEANS 2010, IEEE (XP031832816, ISBN: 978-1-4244-4332-1). A technique of in situ sequential mapping and localization is adopted, which is different from the SLAM in that the mapping and localization are considered as uncoupled states. The background also includes an article “Improving autonomous navigation and positioning for commercial AUV operations” published in pages 1-5 of OCEANS 2015, MTS/IEEE (XP032861839). A technical of in-situ sequential mapping and localization is also adopted to provide the capability to conduct terrain navigation without an existing DTM. In particular, the DTM is not estimated simultaneously as it would be in SLAM. The background further includes the European patent application 18200475.4 (published as EP3451097A1), in which methods and systems for dynamically managing operation of robotic devices in an environment are provided on the basis of a dynamically maintained map of the robotic devices.

Therefore, the present application discloses a method of sequential mapping and localization (SMAL) to solve the localization problem for the mobile object (such as the autonomous vehicle or the robot) in the open environment (such as the airport field and the container terminal). The method of SMAL uses one or more existing natural on-road features for the mapping and localization sequentially.

As a first aspect, the present application discloses a method of sequential mapping and localization (SMAL) (i.e. SMAL method) for navigating a mobile object. The SMAL method comprises a step of generating an initial map of an unknown environment in a mapping process; a step of determining a location of the mobile object in the initial map in a localization process; and a step of guiding the mobile object in the unknown environment, e.g. by creating a control or an instruction to the mobile object. In contrast to the SLAM solution, the SMAL method separates the mapping process in the generating step from the localization process in the computing step. In addition, the series of observations of the unknown environment is not taken over discrete time steps for updating the initial map unless the unknown environment changes greatly near the mobile object.

The unknown environment optionally comprises an open area (such as an airport field or a container terminal) without any beacon. In contrast to current technologies for autonomous vehicles in the open area (such as RFID tags or UWB stations), the SMAL method does not need to build or establish the beacons for detecting the unknown environment and sending signals to the mobile object. In addition, the SMAL method may be concurrently adopted with the current technologies if beacons are built in the unknown environment. Furthermore, the SMAL method may also work jointly with the traditional technologies including the RTK-GNSS/IMU navigation system, High-Definition map (HD-map) and/or the SLAM solution in the unknown environment other than open area, such as urban areas.

The mapping process is used to construct the initial map of the unknown environment. The mapping process of the SMAL method is optionally conducted by a step of collecting a plurality of first environmental data from a detecting device; a step of merging the plurality of first environment data into a fused data (RGB-DD image or point cloud); a step of applying an edge detection to the fused data for detecting edge features; a step of extracting a first set of on-road features from the fused data; and a step of saving the first set of on-road features into the initial map. The first environmental data describes many features of the unknown environment, including the on-road features and the surrounding features. In contrast to the current technologies using surrounding features (such as buildings, trees and poles), the SMAL method is more adaptable in the open area since the on-road features are already available in the open area.

The detecting device of the collecting step optionally comprises a range-based sensor, a vision-based sensor, or a combination thereof. The range-based sensor provides accurate depth information which is nonetheless not rich in features. In contrast, the vision-based sensor provides feature-abundant information which lacks depth estimates. Therefore, a combination of the range-based sensor and the vision-based sensor may provide information having both depth estimates and sufficient features.

The range-based sensor may comprise a light detection and ranging (LIDAR), an acoustic sensor or a combination thereof. The acoustic sensor is also known as sound navigation and ranging (SONAR) sensor that locates a moving object by receiving echoed sound signals bounced off the moving object. The acoustic sensor typically has a power consumption ranging from 0.01 to 1 watt and a depth range from 2 to 5 meters. The acoustic sensor is generally immune to color and transparency and thus suitable for dark environments. In particular, the acoustic sensor may comprise an ultrasonic sensor that uses ultrasonic waves above 20 kHz. The ultrasonic sensor may have higher accuracy of the depth information. In addition, the acoustic sensor has a compact profile within a few cubic inches. However, the acoustic sensor does not work well when the unknown environment has many soft materials since the echoed sound signals are easily absorbed by the soft materials. Performance of the acoustic sensor may be also influenced by other factors of the unknown environment, such as temperature, moisture, and pressure. A compensation may be applied to the performance of the acoustic sensor for correcting its detection results.

The LIDAR has a similar working principle with the acoustic sensor. Instead of sound waves, the LIDAR employs electromagnetic waves (such as light) as the echoed signals. The LIDAR optionally generates a three-dimensional (3D) visualization in 360 degrees of visibility of the unknown environment (called Point Cloud) by firing up to 1 million pulses per second. The LIDAR has a power consumption higher than the acoustic sensor, typically ranging from 50 to 200 watts and a deeper depth range, typically from 50 to 300 meters. In particular, the LIDAR may have a higher depth accuracy and a higher depth accuracy than the acoustic sensor, which are both within a few centimeters (cm). In addition, the LIDAR may also provide an accurate angular resolution ranging from 0.1 to 1 degree. Therefore, the LIDAR is preferred than the acoustic sensor for applications in autonomous vehicles. Forexample, Velodyne HDL-64E LIDAR is suitable for self-driving cars. However, the LIDAR has a bulky profile and is also not suitable for low power applications.

The vision-based sensor comprises a monocular camera, an Omni-directional camera, an event camera, or a combination thereof. The monocular camera may comprise one or more standard RGB cameras, including a color TV and video camera, an image scanner, and a digital camera. The monocular camera optionally has a simple hardware (such as GoPro Hero-4) and a compact profile ranging from a few cubic inches; and thus the monocular camera may be installed to a small mobile object (such as a mobile phone) without any additional hardware. The monocular camera also has a power consumption ranging from 0.01 to 10 watts, since the standard RGB cameras are passive sensors. However, the monocular camera needs to work in conjunction with complex algorithms since the monocular camera cannot directly infer the depth information from a static image. In addition, the monocular camera has a scale-drift problem.

The Omni-directional camera may also comprise one or more standard RGB cameras with 360 degrees’ field of view, such as Samsung Gear 360 having two fish-eye lenses, GoPro Fusion, Ricoh Theta V, Detu Twin, LGR105 and Yi Technology 360VR. The Omni-directional thus may provide a panoramic photography in real-time without any post processing. The Omni-directional camera has a compact profile and a power consumption ranging from 1 to 20 watts. However, the Omni-directional camera cannot provide the depth information.

The event camera (such as dynamic vision sensor) is bio-inspired vision sensor and outputs pixel-level brightness changes, instead of standard intensity frames. Therefore, the event camera has several advantages, such as high dynamic range, no motion blur and a latency in an order of microseconds. The event camera is very power efficient since the event camera does not capture any reductant information. The event camera typically has a power consumption ranging from 0.15 to 1 watt. However, the event camera requires special algorithms that explore high temporal resolution and asynchronous events. Traditional algorithms are not suitable for the event camera which outputs a sequence of asynchronous events rather than actual intensity images.

Alternatively, the detecting device optionally comprises a RGB-D sensor, a stereo-camera, or the alike. The RGB-D sensor or the stereo-camera can provide both the depth information and the feature-abundant information. The RGB-D sensor (such as Microsoft Kinect RGB-D sensor) provides a combination of monocular camera, infrared (IR) transmitter and IR receivers. Therefore, the RGB-D sensor may provide details of a scene and estimated depth of each pixel of the scene. In particular, the RGB-D sensor optionally uses two depth calculation techniques, a structural light (SL) technique or a time-of-flight (TOF) technique. The SL technique uses the IR transmitter for projecting an infrared (IR) speckle pattern which is then captured by the IR receiver. The IR speckle pattern is compared part-by-part to reference patterns that are provided before-hand with known depths. The RGB-D sensor estimates depths at each pixel after matching the IR speckle pattern and the reference patterns. While the TOF technique works in a similar principle with the LIDAR. The RGB-D sensor typically has a power consumption ranging from 2 to 5 watts; and a depth range of 3 to 5 meters. In addition, the RGB-D sensor also has the scale-drift problem due to the monocular camera.

The stereo-camera (such as Bumblebee Stereo Camera) uses a disparity of two camera images which both observe a same scene for calculating the depth information. In contrast to the RGB-D sensor, the stereo-camera is passive camera; and thus does not have the scale-drift problem. The stereo-camera has a power consumption ranging from 2 to 15 watts; and a depth range of 5 to 20 meters. In addition, the stereo-camera generally has a depth accuracy ranging from a few millimeters (mm) to several centimeters (cm).

The mobile object optionally has a communication hub for communicating with the detecting device and a drive mechanism (such as a motor) for moving the mobile object on ground. The mobile object may further comprise a processing unit for receiving the observations of the unknown environment from the communication hub, processing the observations and generating instructions to the drive mechanism for guiding the mobile object to move. Therefore, the detecting device, the processing unit and drive mechanism forms a closed loop for guiding the mobile object to move in the unknown environment. In some implementations, the detecting device is mounted on the mobile object; and thus the detecting device moves with the mobile object (called dynamic detecting device). The dynamic detecting device is optionally on an unblocked position of the mobile object (such as a roof or a top of the mobile object) for detecting 360 degrees of visibility of the unknown environment. In some implementations, the detecting device is constructed statically in the unknown environment and thus does not move along with the mobile object (called static detecting device). The static detecting device sends the observations to the mobile object passing by the static detecting device. Therefore, the static detecting device does not need to obtain observations over discrete time steps since the unknown environment keeps rather stable. Instead, the static detecting device is activated to work only when the unknown environment changes greatly.

The on-road features already exist in the open area (such as public road). The first set of on-road features in the extracting step optionally comprises a marking (such as white marking and yellow marking), a road curb, a grass, a special line, a spot, an edge of the road, edges of different road surfaces or any combination thereof. The on-road features are more accurate and more distinguishable than the surrounding features (such as buildings, trees and poles), especially in night and in raining weather. In some implementations, the detecting device comprises the LIDAR as the range-based sensor and a camera as the vision-based sensor for detecting in real-time, in night and in raining weather. In some implementations, the detecting device comprise the LIDAR only since the LIDAR may provide more accurate localization than the camera in night and in raining weather.

The detecting device may collect noises along with the first environmental data from the unknown environment in the collecting step. The mapping process may further comprise a step of applying a probabilistic approach to the first environmental data for removing noises from the first environmental data. The probabilistic approach separates the noises from the first environmental data (including the on-road features and the surrounding features) by firstly distributing the noises and the first environmental data, then identifying the noises as abnormal information and finally removing the abnormal information from the first environmental data. The probabilistic approach optionally comprises a recursive Bayesian estimation (also known as Bayesian filter). The recursive Bayesian estimation is suitable for estimating dynamic states of a system evolving in time given sequential observations or measurements about the system. Therefore, the recursive Bayesian estimation is applicable for the mapping process which is conducted when the unknown environment changes greatly.

The mapping process is optionally conducted in an offline manner. The mapping process is completed once the saving step is finalized; and would not be activated unless the unknown environment changes greatly. In other words, the initial map would keep the same and not be updated unless the unknown environment changes greatly and thus is not applicable for guiding the mobile object.

The collecting step is optionally conducted in a frame-by-frame manner. In other words, a plurality of frames is collected for presenting the first environmental data. The frames are obtained from the detecting device, such as the camera, the LIDAR or a combination of the camera and the LIDAR.

The merging step is optionally conducted by aligning the frames into a world coordinate system, such as the RTK-GNSS/IMU. In particular, each frame may be associated with a position from the world coordinate system, such as the RTK-GNSS/IMU. Each frame is supposed to be associated with an accurate position from the RTK-GNSS/IMU. The merging step optionally further comprises a step of correcting an inferior frame having an inaccurate position in the world coordinate system, such as the RTK-GNSS/IMU navigation system. The inaccurate position has drifted from its real position of the inferior frame in the RTK-GNSS/IMU. In other words, the accurate position would not be available for being associated with the inferior frame if the GNSS position is drifted from the real position. The correcting step is optionally conducted by referring to original overlaps or overlaps of the inferior frame with other frames having accurate positions (known as normal frames). However, the correcting step needs enough overlaps to determine the accurate position of the inferior frame. If the overlaps are not sufficient for the purpose, the correcting step may comprise a step of collecting additional normal frames from the detecting device near the inferior frame for generating additional overlaps when a number of the original overlaps is below a certain threshold. In other words, additional normal frames are collected near the inferior frame for creating enough overlaps. Alternatively, the inferior frame is abandoned and a new normal frame is collected at the GNSS position of the inferior frame.

The edge detection generally applies a variety of mathematical methods for identifying specific points in the single image or a point cloud. The specific points have discontinuities, i.e. some properties (such as brightness) at each of the specific points change sharply. The specific points are typically organized into a set of line segments known as edges. The edge detection may be used to recognize the on-road features since the on-road features have distinctive properties from their respective neighboring environment. The edge detection optionally comprises blob detection for extracting the on-road features. A blob is defined as a region in which the properties are substantially constant or approximately constant. The properties are thus expressed as a function of each point on the single image or a point cloud. The edge detection may be performed with differential methods or methods based on local extrema to the function or deep learning. The differential methods are based on derivatives of the function with respect to the position; while the methods based on local extrema is targeted to find local maxima and minima of the function. The blob detection optionally comprises a convolution of the single image or point cloud. The blob detection may be performed with different methods, including Laplacians at several scales for finding for a maximum response, clustering with K-means distance, and deep learning.

The mapping algorithm is shown below.

Pseudo-code of mapping algorithm in the SMAL.

Input: images {I} from camera and/or point clouds {C} from Lidar

Output: map M

Algorithm:

Points P = {} // empty set initially
For each frame (an image I and/or a frame of point cloud C)
If I & C
For each point (x,y,z,intensity) in C
Get (R,G,B) of the point from the I
// Assume camera and Lidar have been calibrated properly
Append p = (x,y,z,intensity,R,G,B) to P
0161P00516P
End for
Else if only I
Append I to P
Else if only C
Append C to P
End if
End for
Apply edge detection on P to get edge features E
Apply blob detection on P with E to get on-road features F including markings
Return F as map M

The localization process is used to determine the mobile object in the unknown environment to its corresponding location in the initial map. The localization process is optionally conducted by a step of collecting a plurality of second environmental data near the mobile object; a step of recognizing a second set of on-road features from the second environmental data; a step of matching the second set of on-road features of the unknown environment to the first set of on-road features in the initial map. Then the mobile object is guided to move in the unknown environment based on its location in the initial map. In addition, the location process optionally further comprises a step of updating the location of the mobile object in the initial map after the movement.

In some implementations, the second environmental data are collected from the detecting device (i.e. existing detecting device) that generates the first environmental data, including the dynamic detecting device and the static detecting device. In some implementations, the second environmental data are collected from an additional detecting device. The additional detecting device may also comprise the range-based sensor, the vision-based sensor, or a combination thereof. The additional detecting device may work independently or in conjunction with the existing detecting device.

In contrast to the mapping process, the localization process is optionally conducted in an online manner. In other words, the location of the mobile object in the initial map is updated in consistence with the position of the mobile objection in the unknown environment over discrete time steps.

The unknown environment may comprise static features that do not move while the mobile object passes by them; and dynamic features that actively move around the mobile object. For example, many vehicles may appear in the airport field for transporting passengers and goods. For another example, a few forklifts may work in the container terminal for lifting and moving containers. Therefore, the mobile object should be guided for avoiding any collision with the dynamic features in the unknown environment. The collecting step of the localization process optionally comprises a step of separating a first portion of the second environmental data of a static feature near the mobile object from a second portion of the second environmental data of a dynamic feature near the mobile object.

The collecting step of the location process optionally further comprises a step of tracking the dynamic feature near the mobile object by aggregating observations of the dynamic features over time. In some implementations, the tracking step comprises a step of tracking a specific dynamic feature using a filtering method for estimating its state from the observations over time. In some implementations, the tracking step comprises a step of tracking multiple dynamic features using data association for identifying the observations to their respective dynamic features; and a step of tracking each of the multiple dynamic feature using a filtering method for estimating its state from the observations over time.

The SMAL method may further comprise a step of updating the initial map to a first updated map when the unknown environment changes beyond a first predetermined threshold. The initial map is replaced by the first updated map for guiding the mobile object in the unknown environment. Similarly, the SMAL method may further comprise a step of updating the first updated map to a second updated map when the unknown environment changes beyond a second predetermined threshold. The first updated map is replaced by the second updated map for guiding the mobile object in the unknown environment. Similarly, the SMAL method may also comprise a step of updating the second updated map and other following updated maps when the unknown environment changes beyond a third predetermined threshold and other following predetermined thresholds, respectively.

As a second aspect, the present application discloses a system using sequential mapping and localization (SMAL) for navigating a mobile object. The system comprises a means for generating an initial map of an unknown environment using a mapping mechanism; a means for determining a location of the mobile object in the initial map using a localization mechanism; and a means for guiding the mobile object in the unknown environment by creating a control or an instruction.

The mapping mechanism optionally comprises a means for collecting a plurality of first environmental data from a detecting device; a means for merging the plurality of first environment data into a fused data (RGB-D image or point cloud); a means for applying an edge detection to the fused data for detecting edge features; a means for extracting a first set of on-road features from the fused data; and a means for saving the first set of on-road features into the initial map. In particular, the mapping mechanism may be operated in an offline manner.

The localization mechanism optionally comprises a means for collecting a plurality of second environmental data near the mobile object; a means for recognizing a second set of on-road features from the second environmental data; and a means for matching the second set of on-road features of the unknown environment to the first set of on-road features in the initial map. In particular, the localization mechanism may be operated in an online manner. In addition, the localization mechanism may further comprise a means for updating the location of the mobile object in the initial map.

The system optionally further comprises a means for updating the initial map to a first updated map when the unknown environment changes beyond a first predetermined threshold. In other words, the means for updating the initial map is not activated if the change of the unknown environment is smaller than the first predetermined threshold.

The system optionally further comprises a means for updating the first updated map to a second updated map when the unknown environment changes beyond a second predetermined threshold. In other words, the means for updating the first updated map is not activated if the change of the unknown environment is smaller than the second predetermined threshold. Similarly, the system may also comprise means for updating the second updated map and other following updated maps when the unknown environment changes beyond a third predetermined threshold and other following predetermined thresholds, respectively.

As a third aspect, the present application discloses a computer program product, comprising a non-transitory computer-readable storage medium having computer program instructions and data embodied thereon for implementing a method of sequential mapping and localization (SMAL) for navigating a mobile object. The SMAL method comprises a step of generating an initial map of an unknown environment in a mapping process; a step of determining a location of the mobile object in the initial map in a localization process; and a step of guiding the mobile object in the unknown environment.

The mapping process is optionally conducted by a step of collecting a plurality of first environmental data from a detecting device; a step of merging the plurality of first environment data into a fused data (RGB-D image or point cloud); a step of applying an edge detection to the fused data for detecting edge features; a step of extracting a first set of on-road features from the fused data; and a step of saving the first set of on-road features into the initial map. In particular, the mapping process is operated in an offline manner.

The localization process is optionally conducted by a step of collecting a plurality of second environmental data near the mobile object; a step of recognizing a second set of on-road features from the second environmental data; and a step of matching the second set of on-road features of the unknown environment to the first set of on-road features in the initial map. In particular, the localization mechanism is operated in an online manner. In addition, the localization process may further comprise a step of updating the location of the mobile object in the initial map.

The localization algorithm is shown below.

Pseudo-code of localization algorithm in the SMAL.
Input: map M, a frame of image I from camera and/or point cloud C from Lidar
Output: Pose (position p and orientation o)
Memory: Points P = {}

Algorithm:

If I & C
For each point (x,y,z,intensity) in C
Get (R,G,B) of the point from the I
// Assume camera and Lidar have been calibrated properly
Append p = (x,y,z,intensity,R,G,B) to P
end for
else if only I
Append I to P
else if only C
Append C to P
end if
Apply edge detection on P to get edge features E
Apply blob detection on P with E to get on-road features F including markings
Get a best rotation R and translation T to match F to map M
Get position p from T and orientation o from R
Resampling P if it is too big optionally
Return mobile object’s pose (position p and orientation o)

The SMAL method may further comprise a step of updating the initial map to a first updated map when the unknown environment changes beyond a first predetermined threshold. The SMAL method may further comprise a step of updating the first updated map to a second updated map when the unknown environment changes beyond a second predetermined threshold. Similarly, the SMAL method may also comprise a step of updating the second updated map and other following updated maps when the unknown environment changes beyond a third predetermined threshold and other following predetermined thresholds, respectively.

The accompanying figures (Figs.) illustrate embodiments and serve to explain principles of the disclosed embodiments. It is to be understood, however, that these figures are presented for purposes of illustration only, and not for defining limits of relevant applications.

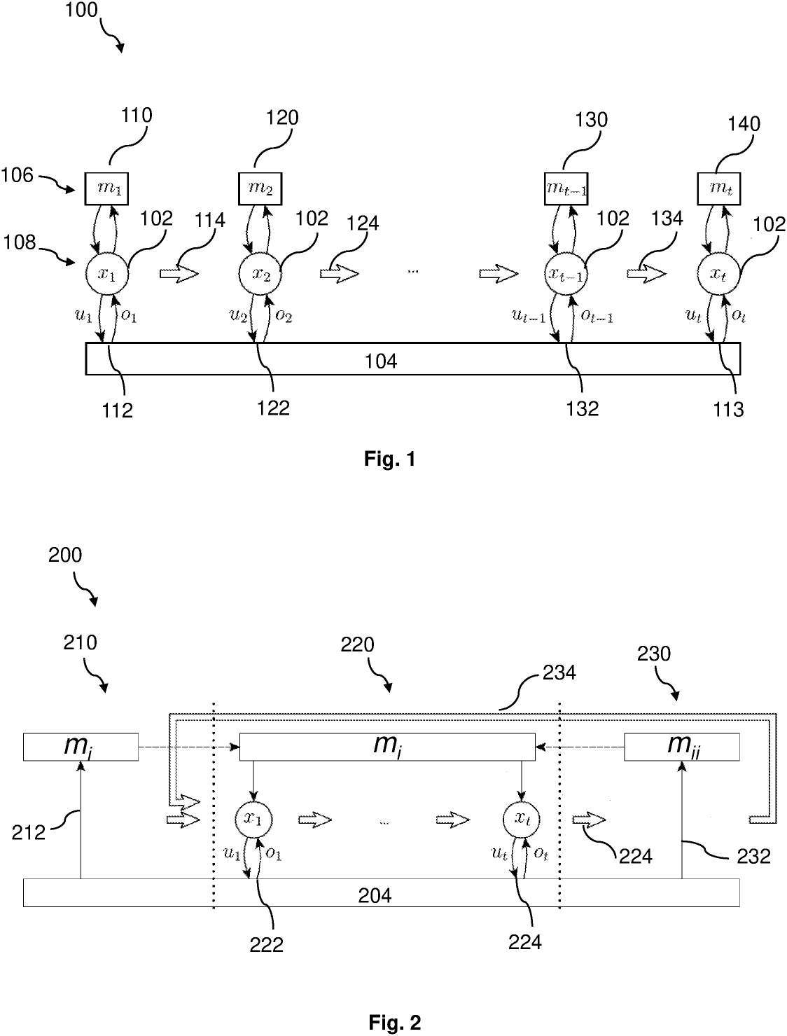

FIG. 1 illustrates a schematic diagram of Simultaneous Localization and Mapping (SLAM) navigation;

FIG. 2 illustrates a schematic diagram of Sequential Mapping and Localization (SMAL) navigation;

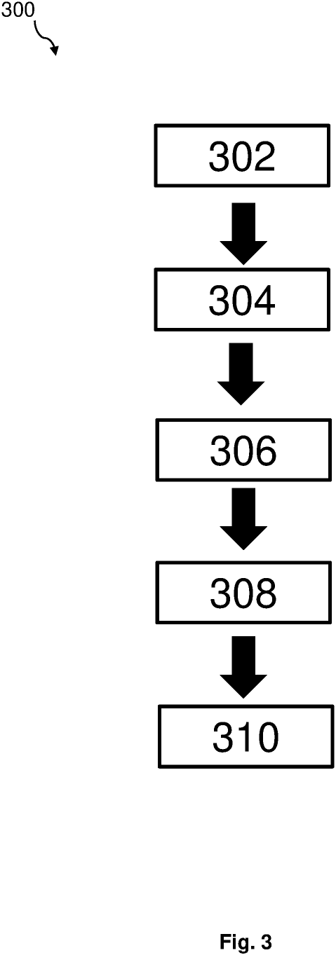

FIG. 3 illustrates a mapping process of the SMAL navigation; and

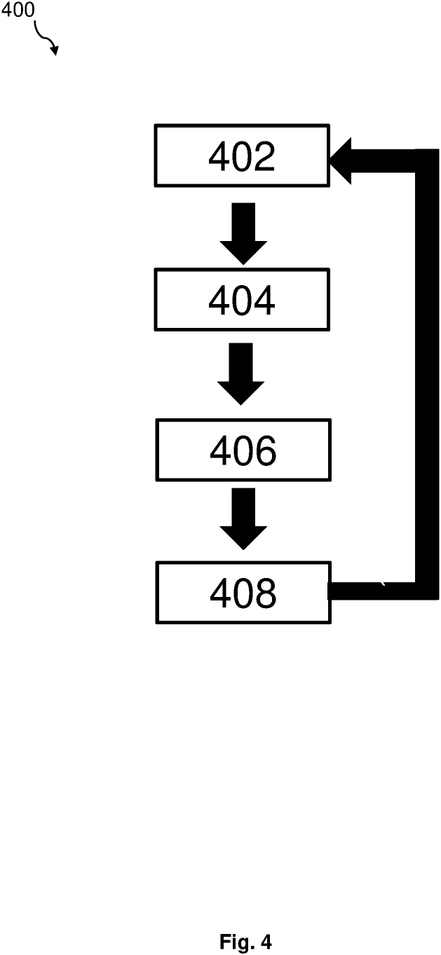

FIG. 4 illustrates a localization process of the SMAL navigation.

FIG. 1 illustrates a schematic diagram of Simultaneous Localization and Mapping (SLAM) navigation 100. The SLAM navigation 100 is used for navigating an autonomous vehicle 102 in an unknown environment 104 from a starting place 112 to a destination place 113. A map 106 of the unknown environment 104 is constructed and updated over discrete time steps (t) for the SLAM navigation 100 to simultaneously keep tracking of a location 108 of the autonomous vehicle 102 in the map 106.

In a first step 110, the autonomous vehicle 102 is at the starting place 112, and first sensor observations o₁ are obtained around the starting place 112. The first sensor observations o₁ are transmitted to the autonomous vehicle 102 for constructing a first map m₁ around the starting place 112. The location 108 of the autonomous vehicle 102 is computed in the first map m₁ as a first location x₁ Then the autonomous vehicle 102 generates a first control u₁ to move the autonomous vehicle 102 from the starting place 112 in the unknown environment 104 according to the first location x₁ in the first map m₁. It is clearly shown that the first map m₁ and the first location x₁ therein are updated simultaneously in the first step 110.

The autonomous vehicle 102 moves from the starting place 112 to a second place 122 after a first discrete time step 114. In a second step 120, the autonomous vehicle 102 is at a second place 122, and second sensor observations o₂ are obtained around the second place 122. The second sensor observations o₂ are transmitted to the autonomous vehicle 102 for updating the first map m₁ to a second map m₂ around the second place 122. The location 108 of the autonomous vehicle 102 in the second map m₂ is accordingly updated as a second location x₂. Then the autonomous vehicle 102 generates a second control u₂ to move the autonomous vehicle 102 from the second place 122 in the unknown environment 104 according to the second location x₂ in the second map m₂. The second map m₂ and the second location x₂ are updated simultaneously in the second step 120.

The autonomous vehicle 102 moves from the second place 122 to a next place after a second discrete time step 124. In this step-by-step manner, the autonomous vehicle 102 moves in the unknown environment 104 continuously. Meanwhile, the location 108 is also updated in the map 106 accordingly. In a second last step 130, the second last sensor observations oₜ₋₁ are obtained around a second last place 132. A second last map mₜ₋₁ around the second last place 132 is updated. The location 108 of the autonomous vehicle 102 in the second last map mₜ₋₁ is accordingly updated as a second last location xₜ₋₁. Then the autonomous vehicle 102 generates a second last control uₜ₋₁ to move the autonomous vehicle 102 from the second last place 132 according to the second last location xₜ₋₁ in the last map mₜ₋₁. The second last map mₜ₋₁ and the second location xₜ₋₁ are updated simultaneously in the second last step 130.

In a last step 140, last sensor observations or are obtained after a second last discrete time step 134 from the unknown environment 104. The last sensor observations oₜ are transmitted to the autonomous vehicle 102 for updating the second last map mₜ₋₁ to a last map mₜ. The location 108 of the autonomous vehicle 102 in the last map mₜ is accordingly updated as a last location xₜ. Then the autonomous vehicle 102 generates a last control uₜ to stop the autonomous vehicle 102 at the destination place 113 according to the last location xₜ in the last map mₜ. Therefore, the last map mₜ and the last location xₜ therein are updated simultaneously in the last step 140.

FIG. 2 illustrates a schematic diagram of Sequential Mapping and Localization (SMAL) navigation 200. The SMAL navigation 200 is also used for navigating an autonomous vehicle 202 in an unknown environment 204. A map 206 of the unknown environment 204 is constructed and updated for the SMAL navigation 200 to simultaneously keep tracking of a location 208 of the autonomous vehicle 202 in the map 206.

The SMAL navigation 200 is divided into three stages, an initial stage 210, a localization stage 220 and a mapping stage 230. In the initial stage 210, initial sensor observations oᵢ are obtained from the unknown environment 204 and transmitted to the autonomous vehicle 202 for generating 212 an initial map mᵢ of the unknown environment 204. The location 208 of the autonomous vehicle 202 is computed as an initial location xᵢ in the initial map mᵢ. Then the autonomous vehicle 202 generates an initial control uᵢ to move the autonomous vehicle 202 in the unknown environment 104 according to the initial location xᵢ in the initial map mᵢ.

In the localization stage 220, first sensor observations o₁ are obtained around a first place 222 in the unknown environment 204. The location 108 of the autonomous vehicle 102 is accordingly computed in the initial map mᵢ. as a first location xᵢ. Then the autonomous vehicle 102 generates a first control _{U1} to move the autonomous vehicle 202 in the unknown environment 204 according to the first location x₁ in the initial map mᵢ. In contrast to the SLAM navigation 100, the first sensor observations oᵢ are used for updating the initial map mᵢ.

The autonomous vehicle 202 moves from the first place 222 to subsequent places over discrete time without updating the initial map mᵢ until a last place 224. Last sensor observations oₜ are obtained around the last place 224 in the unknown environment 204. Similarly, the last sensor observations oₜ are not used for updating the initial map mᵢ. The location 208 of the autonomous vehicle 202 in the unknown environment 204 is updated as a final location xₜ.in the initial map mᵢ. Then the autonomous vehicle 202 generates a last control uₜ to move the autonomous vehicle 202 around the last place 224 to a next place according to the final location xₜ in the initial map mᵢ.

In the mapping stage 230, the initial map mᵢ is not applicable since the unknown environment 104 changes greatly beyond a first predetermined threshold. Updated Sensor observations oᵢᵢ are obtained from the unknown environment 204 and transmitted to the autonomous vehicle 202 for updating 232 the initial map mᵢ to a first updated map mᵢᵢ of the unknown environment 204. Then the localization stage 220 is repeated 234 for guiding the autonomous vehicle 102 to move in the unknown environment 104 with the first updated map mᵢ. Similarly, when the unknown environment 104 changes greatly beyond a second predetermined threshold and subsequent predetermined thresholds, the updated map is mᵢᵢ updated to a second updated map and subsequent updated maps, respectively.

FIG. 3 illustrates a mapping process 300 of the SMAL navigation 200. The mapping process 300 is conducted by a first step of collecting a plurality of first environmental data from a detecting device; a second step 304 of merging the plurality of first environment data into a fused data (RGB-D image or point cloud); a third step 306 of applying an edge detection to the fused data for detecting edge features; a fourth step 308 of extracting a first set of on-road features from the fused data; and a fifth step 310 of saving the first set of on-road features into the initial map. For the SMAL navigation 200, the mapping process 300 is applicable in the initial stage 210 for generating the initial map 212 and in the mapping stage for updating 232 the initial map mᵢ to the first updated map mᵢᵢ. Similarly, the mapping process 300 is also applicable for updating the first updated map, the second updated map and the subsequent updated maps when the unknown environment changes greatly.

In the first step 302, the first environment data are collected frame by frame, either from a LIDAR, a camera or a combination of the LIDAR and the camera as the detecting device. In the second step 304, the frames are aligned and merged into a single frame. During the merge, Real-Time Kinematic (RTK); Global Navigation Satellite System (GNSS), including Global Positioning System (GPS) from USA, Beidou from China, Galileo from Europa and GLONASS from Russian; and Inertial Measurement Unit (IMU) navigation system (abbreviated as RTK-GNSS/IMU navigation system) is also involved. Each frame is associated with its accurate position from the RTK-GNSS/IMU navigation system (known as a normal frame). If a GNSS position of a frame is drifted (known as an inferior frame), the inferior frame would not have an accurate position. In this case, an accurate position of the inferior frame is determined from overlaps of the inferior frame and the normal frames. If no overlap or not sufficient overlaps are found, the inferior frame is abandoned and a new frame is taken near the inferior frame for replacing the inferior frame. In the third step 306, an edge detection algorithm is applied to the single frame to detect the edge features. In the fourth step 308, a blob detection algorithm is applied to the edge features to extract the on-road features from the edge features. In the fifth step 310, the on-road features are integrated into the initial map mᵢ, the first updated map mᵢᵢ, the second updated map and the subsequent updated maps.

FIG. 4 illustrates a localization process 400 of the SMAL navigation 200. The localization process 400 is conducted by a first step 402 of collecting a plurality of second environmental data near the mobile object; a second step 404 of recognizing a second set of on-road features from the second environmental data; a third step 406 of matching the second set of on-road features of the unknown environment to the first set of on-road features in the initial map; and a fourth step of updating the location 108 of the autonomous vehicle 102 in the map 106, including the initial map mᵢ, the first updated map mᵢᵢ, the second updated map and the subsequent updated maps. By repeating the localization stage 220 and the mapping stage 230, the autonomous vehicle 102 is guided to move in the unknown environment 104 by the SMAL navigation 200.

In the application, unless specified otherwise, the terms “comprising”, “comprise”, and grammatical variants thereof, intended to represent “open” or “inclusive” language such that they include recited elements but also permit inclusion of additional, non-explicitly recited elements.

As used herein, the term “about”, in the context of concentrations of components of the formulations, typically means +/- 5% of the stated value, more typically +/- 4% of the stated value, more typically +/- 3% of the stated value, more typically, +/- 2% of the stated value, even more typically +/- 1% of the stated value, and even more typically +/-0.5% of the stated value.

Throughout this disclosure, certain embodiments may be disclosed in a range format. The description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

It will be apparent that various other modifications and adaptations of the application will be apparent to the person skilled in the art after reading the foregoing disclosure without departing from the spirit and scope of the application and it is intended that all such modifications and adaptations come within the scope of the appended claims.

1. A method of sequential mapping and localization (SMAL) for navigating (200) an autonomous vehicle (202), comprising the steps of:
generating (212) an initial map (mᵢ) of an unknown environment (204) in a mapping process (300),
wherein the mapping process (300) is conducted by the steps of
collecting (302) a plurality of first environmental data from observations of at least one sensor;
merging (304) the plurality of first environment data into a fused data, wherein the fused data comprises RGB-D image or point cloud;
applying (306) an edge detection to the fused data;
extracting (308) a first set of on-road features from the fused data; and
saving (310) the first set of on-road features into the initial map (mᵢ);
determining a location (220) of the autonomous vehicle (202) in the initial map (mᵢ) in a localization process (400),
wherein the localization process (400) is conducted by the steps of:
collecting (402) a plurality of second environmental data near the autonomous vehicle (200);
recognizing (404) a second set of on-road features from the second environmental data; and
matching (406) the second set of on-road features of the unknown environment to the first set of on-road features in the initial map (mᵢ);
updating (408) the location (220) of the autonomous vehicle (202) in the initial map (mᵢ); and
guiding the autonomous vehicle (200) in the unknown environment (204) for controlling movement of the autonomous vehicle (200),
wherein the initial map (mᵢ) is constructed using the observations of the at least one sensor.

2. The method of claim 1, wherein the unknown environment (204) comprises an open area where the on-road features are available.

3. The method of claim 1, wherein
the at least one sensor comprises a range-based sensor, a vision-based sensor, or a combination thereof.

4. The method of claim 3, wherein
the range-based sensor comprises a light detection and ranging (LIDAR), an acoustic sensor or a combination thereof.

5. The method of claim 3, wherein
the vision-based sensor comprises a monocular camera, an Omni-directional camera, an event camera, or a combination thereof.

6. The method of claim 1, wherein
the first set of on-road features comprises a marking, a road curb, a grass, an edge of the road, edges of different road surfaces or any combination thereof.

7. The method of claim 1, further comprising
applying a probabilistic approach to the first environmental data for removing noises from the first environmental data.

8. The method of claim 1, wherein
the collecting step (302) is conducted in a frame-by-frame manner.

9. The method of claim 8, wherein
the merging step (304) is conducted by aligning the frames into a world coordinate system.

10. The method of claim 9, wherein
the merging step (304) further comprises correcting an inferior frame having an inaccurate position in the world coordinate system, wherein the correcting step is conducted by referring to original overlaps of the inferior frame with normal frames having accurate positions.

11. The method of claim 10, further comprising
collecting additional normal frames near the inferior frame for generating additional overlaps.

12. The method of claim 1, wherein
the edge detection comprises blob detection for extracting the on-road features.

13. A system using sequential mapping and localization (SMAL) for navigating (200) an autonomous vehicle (202), comprising
a means for generating (212) an initial map (mᵢ) of an unknown environment (204) using a mapping mechanism,
wherein the mapping mechanism is configured to conduct the steps of
collecting (302) a plurality of first environmental data from observations of at least one sensor;
merging (304) the plurality of first environment data into a fused data, wherein the fused data comprises RGB-D image or point cloud;
applying (306) an edge detection to the fused data;
extracting (308) a first set of on-road features from the fused data; and
saving (310) the first set of on-road features into the initial map (mᵢ);
a means for determining a location (220) of the autonomous vehicle (202) in the initial map (mᵢ) using a localization mechanism,
wherein the localization process (400) is conducted by the steps of:
collecting (402) a plurality of second environmental data near the autonomous vehicle (200);
recognizing (404) a second set of on-road features from the second environmental data;
matching (406) the second set of on-road features of the unknown environment to the first set of on-road features in the initial map (mᵢ); and
updating (408) the location (220) of the autonomous vehicle (202) in the initial map (mᵢ); and
a means for guiding the autonomous vehicle (202) in the unknown environment (204) for controlling movement of the autonomous vehicle (200),
wherein the initial map (mᵢ) is constructed using observations of the at least one sensor.

14. A computer program product, comprising a non-transitory computer-readable storage medium having computer program instructions and data embodied thereon for implementing a method of sequential mapping and localization (SMAL) for navigating (200) an autonomous vehicle (202), the SMAL method comprising the steps of
generating (212) an initial map (mᵢ) of an unknown environment (204) in a mapping process (300),
wherein the mapping process (300) is conducted by the steps of
collecting (302) a plurality of first environmental data from observations of at least one sensor;
merging (304) the plurality of first environment data into a fused data, wherein the fused data comprises RGB-D image or point cloud
applying (306) an edge detection to the fused data;
extracting (308) a first set of on-road features from the fused data; and
saving (310) the first set of on-road features into the initial map (mᵢ);
determining a location (220) of the autonomous vehicle (202) in the initial map (mᵢ) in a localization process (400),
wherein the localization process (400) is conducted by the steps of:
collecting (402) a plurality of second environmental data near the autonomous vehicle (200);
recognizing (404) a second set of on-road features from the second environmental data; and
matching (406) the second set of on-road features of the unknown environment to the first set of on-road features in the initial map (mᵢ); and
updating (408) the location (220) of the autonomous vehicle (202) in the initial map (mᵢ); and
guiding the autonomous vehicle (200) in the unknown environment (200), wherein the initial map (mᵢ) is constructed using observations of the at least one sensor.
